(19) United States
(12) Patent Application Publication
(10) Pub. No.: US 2009/0001695 A1
(43) Pub. Date: Jan. 1, 2009

(54) OCCUPANT PROTECTION APPARATUS OF VEHICLE

(75) Inventors: Shigeyuki SUZUKI, Aichi-ken (JP); Kenji FUJIMURA, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 12/147,819

(22) Filed: Jun. 27, 2008

(30) Foreign Application Priority Data
Jun. 28, 2007 (JP) 2007-170444

(51) Int. Cl. B60R 21/26

(52) U.S. Cl. 280/730.2

(57) ABSTRACT

An occupant protection apparatus includes an airbag and an inflator. The airbag is inflated and deployed between a first seat and a second seat, which are adjacent to each other in the vehicle width direction. The inflator supplies gas into the airbag. When the airbag is inflated and deployed, the airbag starts to be inflated and deployed in the vehicle width direction later than inflation and deployment in the vertical direction and the fore-and-aft direction of a vehicle. This permits the occupants seated in the first seat and the second seat to be restrained to the seats in an appropriate manner during inflation and deployment of the airbag.

### BACKGROUND OF THE INVENTION

The present invention relates to an occupant protection apparatus including an airbag that is inflated and deployed between seats in a passenger compartment that are adjacent to each other in the vehicle width direction at an event of a collision of a vehicle.

Typical vehicles have a number of (for example, two) seats that are adjacent to each other in the vehicle width direction in the passenger compartment. Each seat includes a seat portion and a backrest. The backrest of each seat can be reclined independently from the backrest of the other seat. If the reclining angles of the backrests of the seats that are adjacent to each other in the vehicle width direction are different from each other, a gap is formed between the backrests of the seats. The gap is not desirable from the aspect of safety of occupants seated in the seats during a collision of the vehicle, and in particular during a side collision.

Japanese Laid-Open Patent Publication No. 6-211076 discloses an occupant protection apparatus including an airbag that is inflated and deployed to fill the gap generated between the backrests of the adjacent seats when the backrests have different reclining angles. In the occupant protection apparatus of the above publication, the airbag and an inflator for supplying gas into the airbag are accommodated in the front passenger seat at one of the side portions of the backrest closer to the driver's seat. During a collision of the vehicle, gas is supplied from the inflator, so that the airbag is inflated and deployed in the fore-and-aft direction of the vehicle. The inflated and deployed airbag fills the above-mentioned gap, if there is any, between the backrests of the front passenger seat and the driver's seat. However, the airbag is only inflated by an amount that is enough to fill the gap between the backrests of the seats, and is insufficient to suppress the interference between the occupant seated in the front passenger seat and the occupant seated in the driver's seat during a collision of the vehicle.

In order to suppress the interference between the occupants seated in the adjacent seats such as the front passenger seat and the driver's seat during a collision of the vehicle, the airbag that is inflated and deployed between the seats may be simply enlarged. In this case, however, the airbag might push the occupants seated in the seats from diagonally behind while being inflated and deployed upon receipt of gas from the inflator. This hinders restraint of the occupants to the seats in an appropriate manner.

### SUMMARY OF THE INVENTION

Accordingly, it is an objective of the present invention to provide an occupant protection apparatus that, during a collision of a vehicle, inflates and deploys an airbag between seats that are adjacent to each other in the vehicle width direction while restraining occupants seated in the adjacent seats to the seats in an appropriate manner.

To achieve the foregoing and in accordance with a first aspect of the present invention, an occupant protection apparatus including an airbag and an inflator is provided. The airbag is inflated and deployed between a first seat and a second seat, which are adjacent to each other in a width direction of a vehicle. The inflator supplies gas into the airbag. The airbag is controlled to start being inflated and deployed in the vehicle width direction later than inflation and deployment in a vertical direction and a fore-and-aft direction of the vehicle.

In accordance with a second aspect of the present invention, an occupant protection apparatus including an airbag, which is inflated and deployed between a first seat and a second seat, which are adjacent to each other in a width direction of a vehicle, is provided. The airbag before being inflated and deployed is first folded along a first folding line, which extends in a first direction corresponding to a fore-and-aft direction of the vehicle, and then folded along a second folding line, which extends in a second direction corresponding to the vehicle width direction.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view illustrating an occupant protection apparatus according to a first embodiment of the present invention installed in a rear seat of a vehicle;

FIG. 2 is a plan cross-sectional view of an airbag of the occupant protection apparatus shown in FIG. 1 in an inflated and deployed state;

FIG. 3 is a side view of the airbag of the occupant protection apparatus shown in FIG. 1 in the inflated and deployed state;

FIG. 4 is a plan cross-sectional view of the airbag of the occupant protection apparatus shown in FIG. 1 that is halfway inflated and deployed;

FIG. 5 is a front view of the airbag of the occupant protection apparatus shown in FIG. 1 in the inflated and deployed state;

FIG. 6 is a plan cross-sectional view illustrating an airbag of an occupant protection apparatus according to a second embodiment of the present invention;

FIG. 7 is a plan view illustrating an airbag of an occupant protection apparatus according to a third embodiment of the present invention in an inflated and deployed state;

FIG. 8 is a plan view of an airbag of an occupant protection apparatus according to a modified embodiment of the present invention, schematically showing a process of being inflated and deployed;

FIG. 9 is a plan cross-sectional view illustrating an airbag of an occupant protection apparatus according to another modified embodiment of the present invention in an inflated and deployed state;

FIG. 10 is a plan view of an airbag of an occupant protection apparatus according to another modified embodiment of the present invention, schematically showing a process of being inflated and deployed; and

FIG. 11 is a plan view of an airbag of an occupant protection apparatus according to another modified embodiment of the present invention, schematically showing a process of being inflated and deployed.

### DETAILED DESCRIPTION OF THE PREFERRED EMBODIMENTS

### First Embodiment

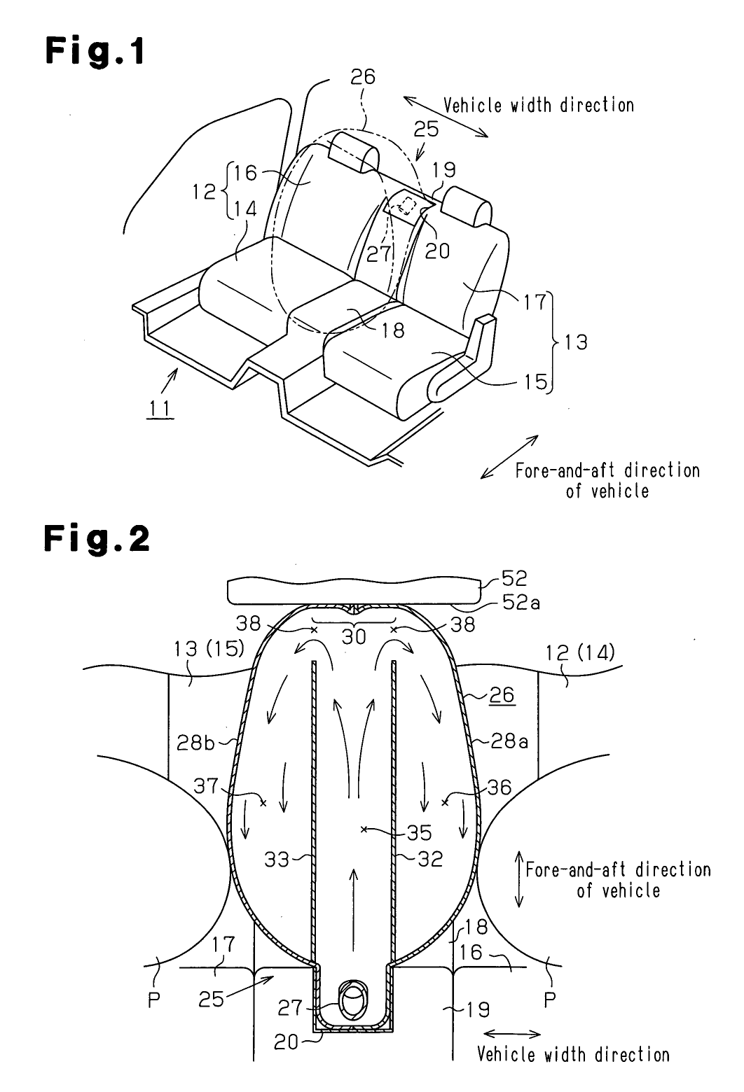

A first embodiment of the present invention will now be described with reference to FIGS. 1 to 5. The advancing direction of a vehicle is defined as the front of the vehicle in the following explanations.

As shown in FIG. 1, a first seat, which is a right rear seat 12 in the first embodiment, and a second seat, which is a left rear seat 13 in the first embodiment, are arranged in a vehicle compartment 11 to be adjacent to each other in the vehicle width direction. The right rear seat 12 includes a seat portion 14 and a backrest 16, and the left rear seat 13 includes a seat portion 15 and a backrest 17. A rear console 18 is provided between the seat portions 14, 15 of the rear seats 12, 13. The dimension of the rear console 18 is substantially the same as that of the seat portions 14, 15 in the fore-and-aft direction of the vehicle. An extended portion 19, which extends upward from the rear end of the rear console 18, is provided between the backrests 16, 17 of the rear seats 12, 13. An accommodation portion 20, which accommodates an airbag 26 and an inflator 27, is provided at the upper section of the extended portion 19.

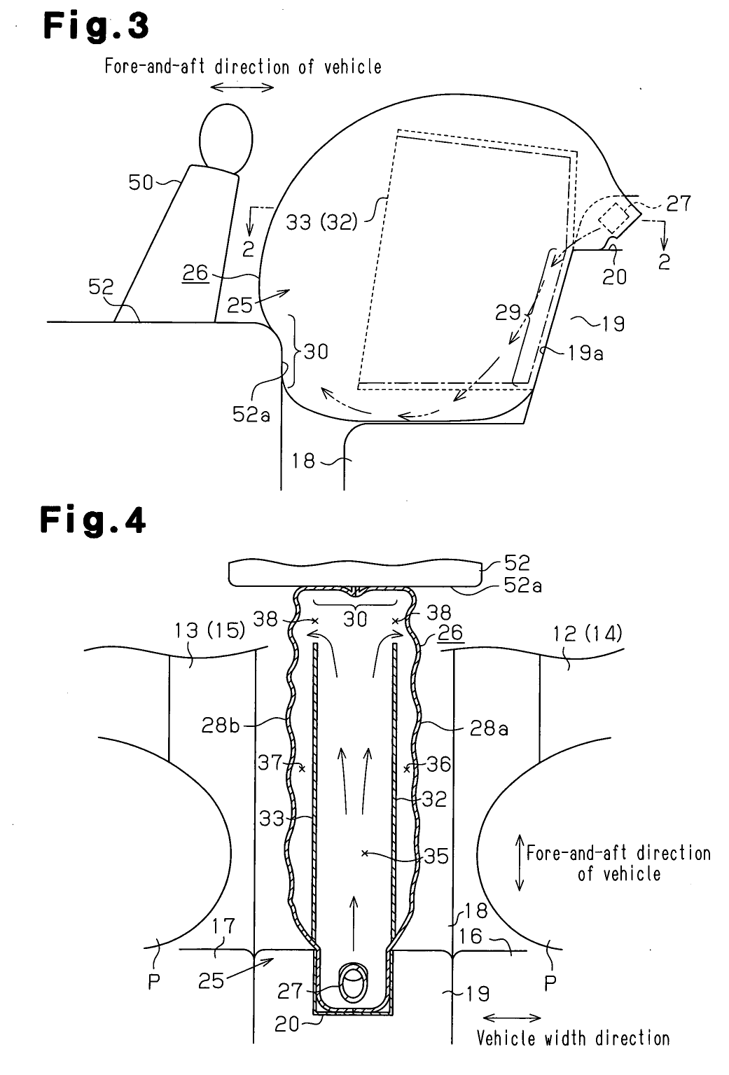

A right front seat 50 shown in FIG. 3 is arranged in front of the right rear seat 12 in the vehicle compartment 11, and a left front seat, which is not shown, is arranged in front of the left rear seat 13 in the vehicle compartment 11. The right front seat 50 and the left front seat are adjacent to each other in the vehicle width direction. A front console 52 is provided between the right front seat 50 and the left front seat. As shown in FIG. 2, the dimension of the front console 52 in the vehicle width direction is greater than the dimension of the rear console 18 in the vehicle width direction.

An occupant protection apparatus 25 according to the first embodiment includes a side impact sensor (not shown) in addition to the airbag 26 and the inflator 27 as shown in FIGS. 1 and 2. When a side collision of the vehicle is detected by the side impact sensor, gas is supplied from the inflator 27, so that the airbag 26 is inflated and deployed to partition the region above the seat portion 14 of the right rear seat 12 and the region above the seat portion 15 of the left rear seat 13 as shown in FIGS. 2 and 3. Thus, when occupants P are seated in the seats 12, 13, respectively, the airbag 26 is inflated and deployed between the occupants P.

As is apparent from FIG. 2, the airbag 26 is formed by, for example, sewing along the periphery of a right ground fabric sheet 28a and a left ground fabric sheet 28b, which are woven cloths. Prior to inflation and deployment, the airbag 26 is accommodated in the accommodation portion 20 in a folded state. As shown in FIGS. 2 and 3, the airbag 26 that has been inflated and deployed comes into a surface contact with a front surface 19a of the extended portion 19 at a rear portion 29, and comes into a surface contact with a rear surface 52a of the front console 52 at a front portion 30. The airbag 26 that has been inflated and deployed also presses the occupants P on both sides of the airbag 26 when the occupants P are seated in the right rear seat 12 and the left rear seat 13, respectively.

A number of partition sheets (two in this embodiment), which are a right partition sheet 32 and a left partition sheet 33, are arranged inside the airbag 26. The partition sheets 32, 33 are parallel to a plane perpendicular to the vehicle width direction in the state where the airbag 26 is inflated and deployed. The right partition sheet 32 and the left partition sheet 33 are sewn to the right ground fabric sheet 28a and the left ground fabric sheet 28b, respectively, by a seam shown by a dashed line in FIG. 3. More specifically, the rear edges of the partition sheets 32, 33 are each sewn to the rearmost end of the corresponding one of the ground fabric sheets 28a, 28b of the inflated and deployed airbag 26 located outside of the accommodation portion 20. Also, the upper edges of the partition sheets 32, 33 are each sewn to the upper portion of the corresponding one of the ground fabric sheets 28a, 28b, and the lower edges of the partition sheets 32, 33 are each sewn to the lower portion of the corresponding one of the ground fabric sheets 28a, 28b. The front edges of the partition sheets 32, 33 are not sewn to the ground fabric sheets 28a, 28b.

Three chambers 35, 36, 37, which are partitioned by the partition sheets 32, 33, are arranged side by side in the vehicle width direction inside the inflated and deployed airbag 26. The center chamber among the chambers 35, 36, 37 is a main chamber 35 into which gas is directly discharged from the inflator 27, the chambers on both sides of the main chamber 35 are sub-chambers 36, 37. The right sub-chamber 36 is connected to the main chamber 35 via a communication passage 38 formed between the front edge of the right partition sheet 32 and the inside of the right ground fabric sheet 28a. The left sub-chamber 37 is connected to the main chamber 35 via a communication passage 38 formed between the front edge of the left partition sheet 33 and the inside of the left ground fabric sheet 28b. The sub-chambers 36, 37 receive gas from the main chamber 35 via the communication passages 38.

The inflator 27 discharges gas diagonally downward and forward as shown in FIG. 3. Thus, when gas is discharged into the airbag 26 from the inflator 27, the main chamber 35 deploys diagonally downward and forward along the front surface 19a of the extended portion 19, and thereafter the entire main chamber 35 is inflated. As a result, the airbag 26 is inflated and deployed mainly in the vertical direction and the fore-and-aft direction of the vehicle. Subsequently, part of the gas in the main chamber 35 flows into the sub-chambers 36, 37 via the communication passages 38, and the sub-chambers 36, 37 are inflated. As a result, the airbag 26 is inflated and deployed mainly in the vehicle width direction. In this manner, the airbag 26 is inflated and deployed in the vehicle width direction later than the inflation and deployment of the airbag 26 in the vertical direction and the fore-and-aft direction of the vehicle.

The operations of the occupant protection apparatus 25 when the occupants P are seated in the rear seats 12, 13 will now be described with reference to FIGS. 3 to 5.

When the side impact sensor detects a side collision of the vehicle, the inflator 27 discharges gas into the airbag 26 accommodated in the accommodation portion 20. Since gas is discharged from the inflator 27 diagonally downward and forward, when gas is discharged into the airbag 26 from the inflator 27, the main chamber 35 is first deployed diagonally downward and forward along the front surface 19a of the extended portion 19, and then the entire main chamber 35 is inflated. As a result, the airbag 26 is inflated and deployed mainly in the vertical direction and the fore-and-aft direction of the vehicle as shown in FIG. 3. Accordingly, the region above the seat portion 14 of the right rear seat 12 and the region above the seat portion 15 of the left rear seat 13 are partitioned by the airbag 26. That is, the airbag 26 is arranged between the occupants P seated in the rear seats 12, 13.

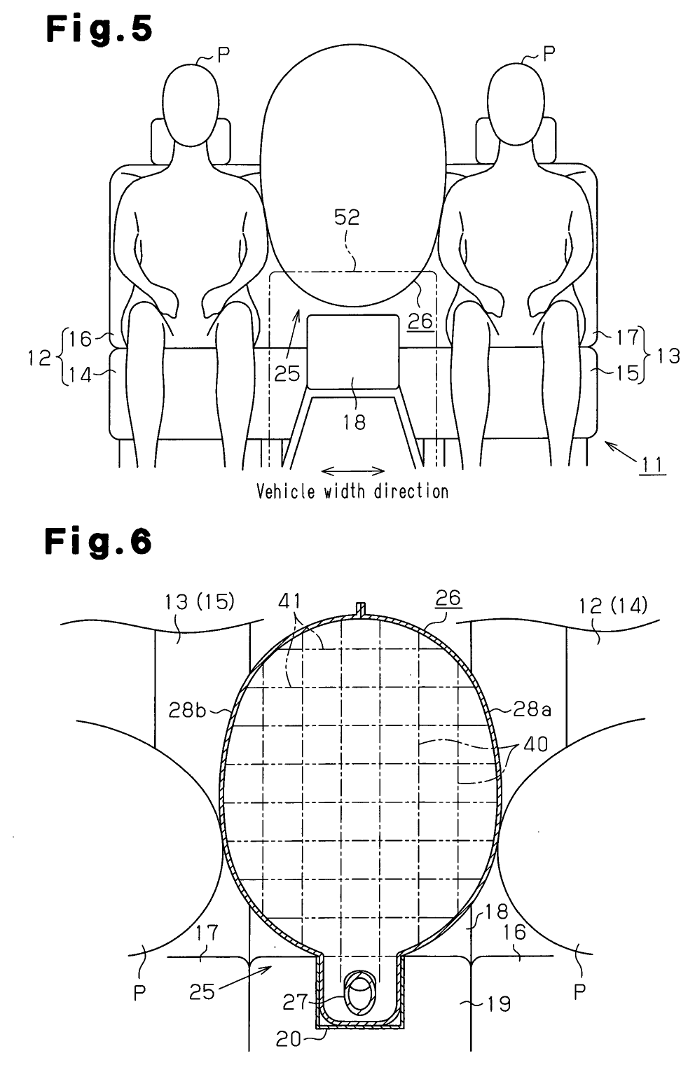

When the inflation of the entire main chamber 35 is substantially completed, in accordance with the supply of gas from the inflator 27, part of the gas in the main chamber 35 flows into the sub-chambers 36, 37 via the communication passages 38 as shown in FIG. 4, and the sub-chambers 36, 37 start to be inflated. When the sub-chambers 36, 37 are inflated, the airbag 26 is inflated and deployed mainly in the vehicle width direction. As a result of inflating and deploying in the vehicle width direction, the airbag 26 presses the occupants P seated in the rear seats 12, 13 on both sides of the airbag 26 in the vehicle width direction as shown in FIG. 5. In this manner, the airbag 26 is inflated and deployed in the vehicle width direction from the state of being arranged between the occupants P on the rear seats 12, 13. Thus, the airbag 26 does not push the occupants P in the rear seats 12, 13 from diagonally rearward, and the occupants P are each restrained to the corresponding one of the rear seats 12, 13 in an appropriate manner.

The first embodiment has the following advantages.

(1) If a side collision of the vehicle is detected when the occupants P are seated in the rear seats 12, 13, the airbag 26 is first inflated and deployed mainly in the vertical direction and the fore-and-aft direction of the vehicle to suppress interference between the occupants P. Thereafter, the airbag 26 is inflated and deployed mainly in the vehicle width direction. Thus, the airbag 26 does not push the occupants P seated in the rear seats 12, 13 forward as to cancel the restraint to the rear seats 12, 13 during inflation and deployment, and the occupants P are each restrained to the corresponding one of the rear seats 12, 13 in an appropriate manner.

(2) The gas discharged from the inflator 27 is first supplied to the main chamber 35, so that, by the inflation of the main chamber 35, the airbag 26 is inflated and deployed mainly in the vertical direction and the fore-and-aft direction of the vehicle. Thereafter, part of the gas in the inflated and deployed main chamber 35 flows into the sub-chambers 36, 37 via the communication passages 38. Thus, by the inflation of the sub-chambers 36, 37, the inflation and deployment of the airbag 26 occurs mainly in the vehicle width direction after a time lag. Therefore, the inflation and deployment of the airbag 26 in the vehicle width direction is reliably started later than the inflation and deployment of the airbag in the vertical direction and the fore-and-aft direction of the vehicle.

(3) The communication passages 38, which connect the main chamber 35 to the sub-chambers 36, 37, are arranged at the downstream region of the gas supplied to the main chamber 35 from the inflator 27. In other words, the communication passages 38 are arranged as far as possible from the inflator 27. Thus, the inflation of the sub-chambers 36, 37 is reliably started later than the inflation of the main chamber 35.

(4) The airbag 26 before being inflated and deployed is accommodated in the accommodation portion 20 of the extended portion 19 arranged between the backrests 16, 17 of the rear seats 12, 13. In this case, for example, as compared to a case where the airbag 26 is accommodated in the vehicle ceiling, the airbag 26 before being inflated and deployed is arranged closer to the occupants P seated in the rear seats 12, 13. Thus, during a collision of the vehicle, the occupants P in the rear seats 12, 13 are quickly protected by the airbag 26.

(5) When a side collision of the vehicle occurs, if the occupant P seated in either of the rear seats 12, 13 falls into the inflated and deployed airbag 26, the airbag 26 acts to move in the vehicle width direction as it is pushed by the occupant P. However, the inflated and deployed airbag 26 presses the front surface 19a of the extended portion 19 at the rear portion 29, and presses the rear surface 52a of the front console 52 at the front portion 30. Therefore, the frictional force at the contact portion between the airbag 26 and the extended portion 19 and the frictional force at the contact portion between the airbag 26 and the front console 52 suppress the movement of the airbag 26 in the vehicle width direction caused by receiving the occupant P who falls into the airbag 26. This permits each of the occupants P in the rear seats 12, 13 to be restrained to the corresponding one of the rear seats 12, 13 more appropriately.

### Second Embodiment

A second embodiment of the present invention will now be described with reference to FIG. 6. An occupant protection apparatus 25 according to the second embodiment differs from the occupant protection apparatus 25 according to the first embodiment mainly in that it is not provided with the partition sheets 32, 33 in the airbag 26, and the airbag 26 is folded in a certain manner. In the following explanation, the differences from the first embodiment will mainly be discussed, and like or the same reference numerals are given to those components that are like or the same as the corresponding components of the first embodiment.

The airbag 26 of the occupant protection apparatus 25 according to the second embodiment is first accordion-folded along first folding lines 40 shown by the dashed lines in FIG. 6 extending in a first direction corresponding to the fore-and-aft direction of the vehicle, and subsequently accordion-folded along second folding lines 41 shown by the chain double-dashed lines in FIG. 6 extending in a second direction corresponding to the vehicle width direction. The airbag 26 is accommodated in the accommodation portion 20 in such a folded state. Therefore, when gas is supplied from the inflator 27, the airbag 26 accommodated in the accommodation portion 20 is first unfolded along the second folding lines 41, so that the airbag 26 is deployed in the fore-and-aft direction of the vehicle. After the airbag 26 is unfolded along the second folding lines 41, the airbag 26 is unfolded along the first folding lines 40, so that the airbag 26 is deployed in the vehicle width direction.

Furthermore, in the occupant protection apparatus 25 of the second embodiment, the inflated and deployed airbag 26 does not press the front console 52 at the front portion 30, but comes into a surface contact with the upper surface of the rear console 18 at its lower portion.

The second embodiment has the following advantages in addition to the advantages (1) and (4) of the first embodiment.

(6) The airbag 26 before being inflated and deployed is accommodated in the accommodation portion 20 in the state where the airbag 26 is folded along the first folding lines 40, which extend in the first direction corresponding to the fore-and-aft direction of the vehicle, and then folded along the second folding lines 41, which extend in the second direction corresponding to the vehicle width direction. When the airbag 26 before being inflated and deployed is supplied with gas from the inflator 27, the airbag 26 is restricted from being unfolded along the first folding lines 40 by the folding of the airbag 26 along the second folding lines 41. As a result, the airbag 26 is unfolded along the first folding lines 40 only after the airbag 26 is unfolded along the second folding lines 41. Therefore, even if the partition sheets 32, 33 are omitted, the airbag 26 is inflated and deployed in the vehicle width direction later than the inflation and deployment of the airbag 26 in the vertical direction and the fore-and-aft direction of the vehicle.

(7) When a side collision of the vehicle occurs, if the occupant P seated in either of the rear seats 12, 13 falls into the inflated and deployed airbag 26, the airbag 26 acts to move in the vehicle width direction as it is pushed by the occupant P. However, the inflated and deployed airbag 26 presses the front surface 19a of the extended portion 19 at the rear portion 29, and presses the upper surface of the rear console 18 at its lower portion. Therefore, the frictional force at the contact portion between the airbag 26 and the extended portion 19 and the frictional force at the contact portion between the airbag 26 and the rear console 18 suppress the movement of the airbag 26 in the vehicle width direction caused by the occupant P who falls into the airbag 26. This permits each of the occupants P in the rear seats 12, 13 to be restrained to the corresponding one of the rear seats 12, 13 more appropriately.

### Third Embodiment

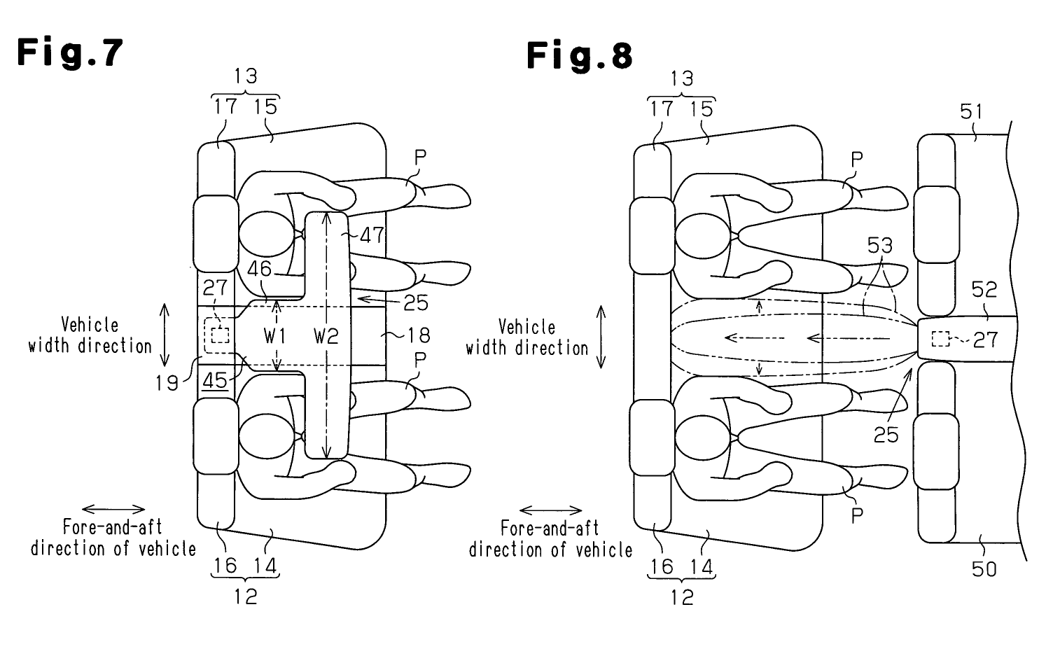

A third embodiment of the present invention will now be described with reference to FIG. 7. An occupant protection apparatus 25 according to the third embodiment differs from the occupant protection apparatus 25 according to the first embodiment mainly in that it is provided with, instead of the airbag 26, an airbag 45 including regions with different dimensions in the vehicle width direction when being inflated. In the following explanation, the differences from the first embodiment will mainly be discussed, and like or the same reference numerals are given to those components that are like or the same as the corresponding components of the first embodiment.

As shown in FIG. 7, the inflated and deployed airbag 45 has a narrow portion 46 and a wide portion 47. A dimension W2 of the wide portion 47 in the vehicle width direction is greater than a dimension W1 of the narrow portion 46 in the vehicle width direction. The narrow portion 46 is arranged at the proximal end (rear end) of the airbag 45, and the wide portion 47 is arranged at the distal end (front end) of the airbag 45. Thus, the inflated and deployed airbag 45 has a T-shape in a plan view.

The narrow portion 46 of the inflated and deployed airbag 45 is arranged between the occupants P seated in the rear seats 12, 13, and suppresses the occupants P from moving in the vehicle width direction. The wide portion 47 of the inflated and deployed airbag 45 is arranged immediately in front of the occupants P seated in the rear seats 12, 13, and suppresses the occupants P from moving in the fore-and-aft direction of the vehicle.

The third embodiment has the following advantages in addition to the advantages (1) to (4) of the first embodiment.

(8) If the wide portion 47 is arranged at the rear end of the airbag 45, the wide portion 47 is inflated and deployed in the vehicle width direction before inflation and deployment of the airbag 45 in the fore-and-aft direction of the vehicle is completed. As a result, the occupants P seated in the rear seats 12, 13 might be pushed forward by the airbag 45. In this respect, in the third embodiment, the wide portion 47 is arranged at the front end of the airbag 45 away from the inflator 27 instead of at the rear end of the airbag 45 close to the inflator 27. Therefore, the wide portion 47 is prevented from being inflated and deployed in the vehicle width direction before the inflation and deployment of the airbag 45 in the fore-and-aft direction of the vehicle is completed. Thus, each of the occupants P seated in the rear seats 12, 13 is restrained to the corresponding one of the rear seats 12, 13 in an appropriate manner.

(9) The wide portion 47 of the inflated and deployed airbag 45 is arranged immediately in front of the occupants P seated in the rear seats 12, 13, and suppresses the occupants P from moving in the fore-and-aft direction of the vehicle. This permits each of the occupants P in the rear seats 12, 13 to be restrained to the corresponding one of the rear seats 12, 13 more appropriately.

The above-mentioned embodiments may be modified as follows.

The accommodation portion 20 may be located at the lower portion of the extended portion 19 instead of the upper portion of the extended portion 19. In this case, the inflator 27 preferably discharges gas diagonally upward and forward instead of diagonally downward and forward.

The accommodation portion 20 may be provided in the vehicle ceiling. In this case also, the airbag 26 or the airbag 45 is inflated and deployed in the vehicle width direction after it is inflated and deployed in the vertical direction and the fore-and-aft direction of the vehicle.

The accommodation portion 20 may be provided in the rear console 18. In this case also, the airbag 26 or the airbag 45 is inflated and deployed in the vehicle width direction after it is inflated and deployed in the vertical direction and the fore-and-aft direction of the vehicle.

The accommodation portion 20 may be provided in the front console 52 located between the front seats 50, 51 as shown in FIG. 8. In this case, an airbag 53 is first inflated and deployed in the vertical direction and the fore-and-aft direction of the vehicle as shown by the chain double-dashed line in FIG. 8 to partition the region above the seat portion 14 of the right rear seat 12 and the region above the seat portion 15 of the left rear seat 13, and thereafter, the airbag 53 is inflated and deployed in the vehicle width direction as shown by the dashed line in FIG. 8.

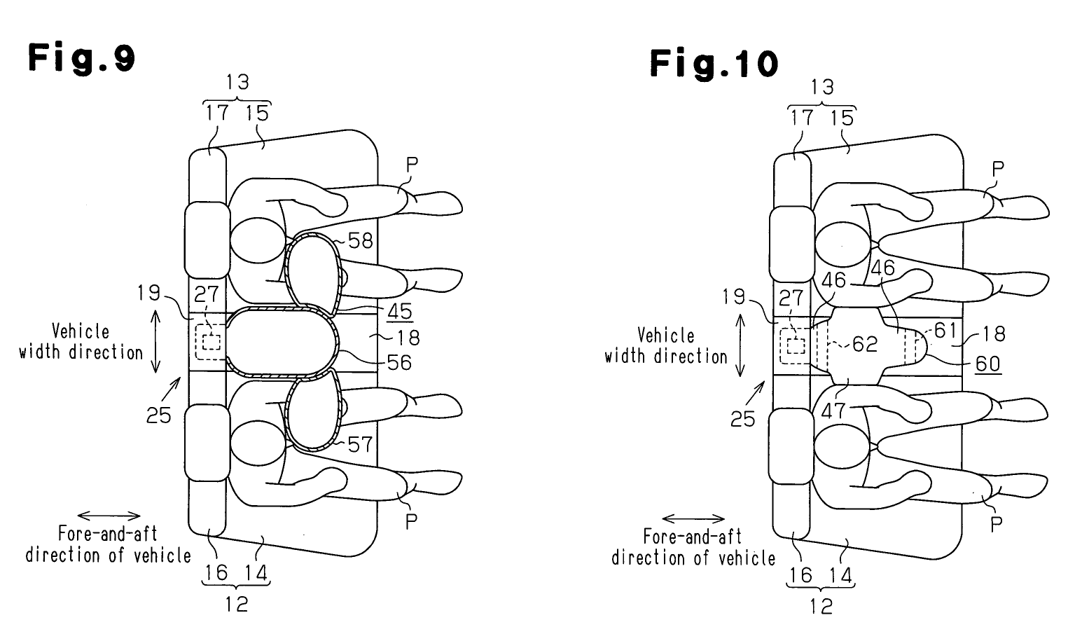

In the third embodiment, the airbag 45 may be configured by a number of airbag sections. For example, as shown in FIG. 9, the airbag 45 may be configured by three airbag sections 56, 57, 58. A first airbag section 56 is inflated and deployed forward from the extended portion 19. A second airbag section 57 and a third airbag section 58 are arranged on both sides of the first airbag section 56, and communicate with the first airbag section 56 at the front end of the first airbag section 56. When gas is supplied from the inflator 27 into the airbag 45, the first airbag section 56 is first inflated and deployed, and thereafter, part of the gas in the first airbag section 56 flows into the second airbag section 57 and the third airbag section 58, so that the second airbag section 57 and the third airbag section 58 are inflated and deployed. That is, the first airbag section 56 corresponds to the narrow portion 46, and the second airbag section 57 and the third airbag section 58 correspond to the wide portion 47. With this configuration also, the occupants P seated in the rear seats 12, 13 are suppressed from moving in the fore-and-aft direction of the vehicle.

In the third embodiment, as shown in FIG. 10, the wide portion 47 may be provided at the middle of an airbag 60 in the fore-and-aft direction. In this case, the narrow portion 46 is arranged in front and rear of the wide portion 47. With this configuration, side portions of the wide portion 47 in the vehicle width direction press the occupants P seated in the rear seats 12, 13, so that the airbag 60 reliably restrains the occupants P in the rear seats 12, 13.

As shown in FIG. 10, when providing the wide portion 47 at the middle of the airbag 60 in the fore-and-aft direction, the narrow portions 46 may be formed by restricting inflation and deployment of the front and rear portions of the airbag 60 in the vehicle width direction using tethers 61, 62 provided inside the airbag 60. In this case, the airbag 60 can be manufactured from ground fabric sheets 28a, 28b having a simple shape.

In the first and third embodiments, the airbag 26 or the airbag 45 before being inflated and deployed may be accommodated in the accommodation portion 20 in the folded state as described in the second embodiment.

In the first and third embodiments, the communication passage 38 that connects the main chamber 35 to the sub-chamber 36 may be a through hole formed in the partition sheet 32, which partitions the main chamber 35 and the sub-chamber 36, and the communication passage 38 that connects the main chamber 35 to the sub-chamber 37 may be a through hole formed in the partition sheet 33, which partitions the main chamber 35 and the sub-chamber 37. In this case, the front edge of each of the partition sheets 32, 33 may be sewn to the corresponding one of the ground fabric sheets 28a, 28b.

In the first and third embodiments, the front edge of each of the partition sheets 32, 33 may be sewn to the corresponding one of the ground fabric sheets 28a, 28b. However, the sewn parts of the front edges of the partition sheets 32, 33 and the ground fabric sheets 28a, 28b preferably have a breaking strength of a degree that allows the sewn parts to break by the pressure of gas supplied to the main chamber 35.

In the first and third embodiments, the number of the sub-chambers 36, 37 in the airbag 26 or the airbag 45 may be one, or may be three or more.

The occupant protection apparatus 25 in each of the above embodiments may be modified to be used for the front seats instead of the rear seats, in which, for example, the airbag is inflated and deployed to partition the region above the seat portion of the driver's seat and the region above the seat portion of the front passenger seat. In this case, the airbag and the inflator may be accommodated in the front console between the adjacent front seats, or in the instrument panel.

The occupant protection apparatus 25 in each of the above embodiments may be modified, such that the airbag is inflated and deployed between the seats that are directly adjacent to each other in the vehicle width direction and do not sandwich the console or the like. In this case, the airbag before being inflated and deployed is desirably accommodated in one of the adjacent seats on one of its side portions closer to the other seat.

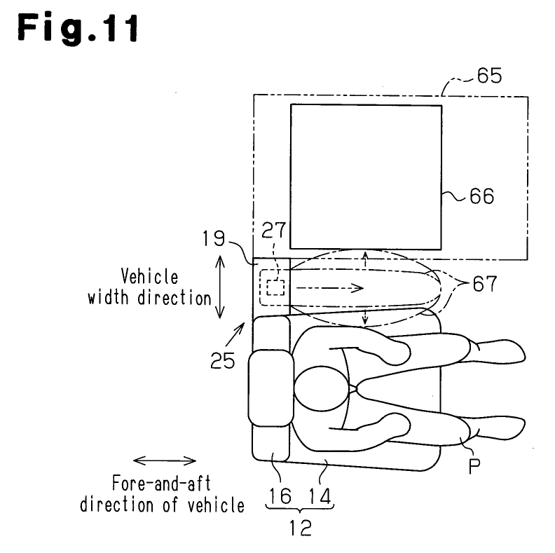

The occupant protection apparatus 25 in each of the above embodiments may be modified, such that, as shown in FIG. 11, an airbag 67 is inflated and deployed to partition the region above the seat portion 14 of the right rear seat 12 and a space 65 on the left side of the right rear seat 12. In this case also, the airbag 67 is first inflated and deployed in the vertical direction and the fore-and-aft direction of the vehicle as shown by the chain double-dashed line in FIG. 11, and thereafter inflated and deployed in the vehicle width direction as shown by the dashed line in FIG. 11. With this configuration, when a piece of baggage 66 is placed in the space 65, the airbag 67 suppresses interference between the baggage piece 66 and the occupant P seated in the right rear seat 12 without pushing the baggage piece 66 and the occupant P forward during inflation and deployment.

1. An occupant protection apparatus comprising:
an airbag, which is inflated and deployed between a first seat and a second seat, which are adjacent to each other in a width direction of a vehicle; and
an inflator, which supplies gas into the airbag,
wherein the airbag is controlled to start being inflated and deployed in the vehicle width direction later than inflation and deployment in a vertical direction and a fore-and-aft direction of the vehicle.

2. The apparatus according to claim 1, wherein the airbag includes a main chamber, which inflates and deploys the airbag mainly in the vertical direction and the fore-and-aft direction of the vehicle, and a sub-chamber, which is located on a side of the main chamber and inflates and deploys the airbag mainly in the vehicle width direction, the main chamber communicates with the sub-chamber via a communication passage, the main chamber directly receives gas from the inflator to be inflated and deployed, and the sub-chamber is inflated and deployed when gas supplied from the inflator to the main chamber flows into the sub-chamber via the communication passage.

3. The apparatus according to claim 2, wherein the communication passage is arranged in a downstream region of gas supplied from the inflator to the main chamber.

4. The apparatus according to claim 1, wherein the airbag before being inflated and deployed is first folded along a first folding line, which extends in a first direction corresponding to the fore-and-aft direction of the vehicle, and then folded along a second folding line, which extends in a second direction corresponding to the vehicle width direction.

5. The apparatus according to claim 1, wherein the inflated and deployed airbag has a narrow portion and a wide portion, the dimension of the wide portion in the vehicle width direction is greater than the dimension of the narrow portion in the vehicle width direction, and the wide portion is arranged forward of the narrow portion.

6. The apparatus according to claim 5, wherein the wide portion is arranged at the front end of the inflated and deployed airbag.

7. The apparatus according to claim 1, wherein a console is provided between the first seat and the second seat, an extended portion extends upward from a rear end of the console, and the airbag before being inflated and deployed and the inflator are accommodated in the extended portion.

8. An occupant protection apparatus comprising an airbag, which is inflated and deployed between a first seat and a second seat, which are adjacent to each other in a width direction of a vehicle,
wherein the airbag before being inflated and deployed is first folded along a first folding line, which extends in a first direction corresponding to a fore-and-aft direction of the vehicle, and then folded along a second folding line, which extends in a second direction corresponding to the vehicle width direction.

9. The apparatus according to claim 8, wherein a console is provided between the first seat and the second seat, an extended portion extends upward from a rear end of the console, and the airbag before being inflated and deployed is accommodated in the extended portion.
